(19) United States
(12) Patent Application Publication
(10) Pub. No.: US 2007/0044296 A1
(43) Pub. Date: Mar. 1, 2007

(54) METHOD OF MANUFACTURING FILM BULK ACOUSTIC WAVE RESONATOR

(75) Inventors: Tae Yeol Jeon, KYUNGKI-DO (KR); Chul Hwan Jung, KYUNGKI-DO (KR); Sung Hwan Lee, KYUNGKI-DO (KR); In Ho Jeong, DAEJEON (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/466,680

(22) Filed: Aug. 23, 2006

(30) Foreign Application Priority Data
Aug. 24, 2005 (KR) 10-2005-0077857

(51) Int. Cl. H04R 17/00

(52) U.S. Cl. 29/594; 333/193; 310/324; 310/328; 29/25.35; 29/609.1

(57) ABSTRACT

The invention relates to a method of manufacturing an FBAR having a cap made of solid metal. The method includes preparing a substrate and stacking a lower electrode, a piezoelectric film and an upper electrode on the substrate to form a resonance region. The method also includes forming a passivation layer above substantially an entire area of the resonance region and its adjacent region to protect the resonance region and forming a first photoresist layer on the passivation layer. The first photoresist layer exposes a sidewall region which surrounds the resonance region. The method further includes filling in the sidewall region with metal and forming a roof with the same metal on the resonance region surrounded by the sidewall region, thereby forming a cap composed of the sidewall and the roof.

### CLAIM OF PRIORITY

This application claims the benefit of Korean Patent Application No. 2005-77857 filed on Aug. 24, 2005, in the Korean Intellectual Property Office, the disclosure of which is incorporated herein by reference.

### BACKGROUND OF THE INVENTION

1. Field of the Invention

The present invention relates to a method of manufacturing a Film Bulk Acoustic wave Resonator (hereinafter, referred to as FBAR), and more particularly, to a method of manufacturing an FBAR having a solid cap which can protect a resonance region thereof from foreign material and external mechanical force and ensure a function of electromagnetic shielding.

2. Description of the Related Art

With the recent trend of miniaturization and high functionality of mobile telecommunication terminals, there have been rapid developments in the field of the mobile telecommunication terminal components such as radio frequency (RF) components. In particular, Film Bulk Acoustic wave Resonators (FBARs) has an advantage that it can achieve the desired level of integration and miniaturization while incurring small insertion loss than other filters. Thus, they are popularized as a core passive component of RF mobile telecommunication components.

An FBAR refers to a film type device which utilizes resonance induced between a load and a mechanical stress generated on a surface of a piezoelectric film made of dielectric material such as ZnO and AlN. The resonance frequency of the FBAR is determined by the total thickness of the resonance region composed of the piezoelectric layer and upper and lower electrodes. However, it is almost impossible to form the layer of each device in the same thickness in a wafer with the current technology (an error of approximately 1% of the thickness of the layer exists). Particularly, the frequency of the device may change due to oxidation of an upper electrode made of metal and adsorption of foreign material onto the electrode. In addition, the frequency of the device may also change due to the effects from external electromagnetic waves.

Therefore, the FBAR typically has a cap for isolating and protecting the resonance region from the external environment.

Conventionally, there have been used two methods for forming a cap of an FBAR.

The first method suggests forming a sidewall around the resonance region of the FBAR and forming a roof on the sidewall using a dry film.

In this method, however, as the sidewall and the roof are formed with a dry film, the cap may be damaged in a subsequent process such as molding, and the device may have low reliability due to permeation of moisture during a reliability test afterwards.

The other conventional method involves a wafer level package technique, in which, a wafer with a cavity formed therein is prepared and applied as a cap onto a wafer with an FBAR formed thereon.

This conventional method using the wafer level package technique has drawbacks in that an additional wafer is needed to form the cap, increasing the costs, and a high level of skill is required for combining the wafer for the cap with the wafer having the FBAR.

In particular, the aforementioned conventional methods do not provide a function of electromagnetic shielding to protect the FBAR.

Therefore, there exists a need in the art for a method of manufacturing an FBAR including a cap which can protect the resonance region thereof from foreign material and external mechanical force, having a function of electromagnetic shielding.

### SUMMARY OF THE INVENTION

The present invention has been made to solve the foregoing problems of the prior art and therefore an object of certain embodiments of the present invention is to provide a method of manufacturing an FBAR having a cap which can protect a resonance region thereof, composed of a lower electrode, a piezoelectric film and an upper electrode stacked on one another, from foreign material and external mechanical force, and ensure a function of electromagnetic shielding.

According to an aspect of the invention for realizing the object, there is provided a method of manufacturing a Film Bulk Acoustic wave Resonator (FBAR) including steps of:

(a) preparing a substrate;

(b) stacking a lower electrode, a piezoelectric film and an upper electrode on the substrate to form a resonance region in which the lower electrode, the piezoelectric film and the upper electrode are overlapped on one another;

(c) forming a passivation layer above substantially an entire area of the resonance region and its adjacent region to protect the resonance region;

(d) forming a first photoresist layer on the passivation layer, the first photoresist layer exposing a sidewall region which surrounds the resonance region; and

(e) filling in the sidewall region with metal and forming a roof with the same metal on the resonance region surrounded by the sidewall region, thereby forming a cap composed of the sidewall and the roof.

According to certain embodiments of the invention, the passivation layer is made of an oxide or a nitride of one selected from a group consisting of Si, Zr, Ta, Ti, Hf and Al.

According to certain embodiments of the invention, the step (c) comprises one selected from a group consisting of sputtering, evaporation and chemical deposition.

According to certain embodiments of the invention, it is preferable that the method may further include forming a connection pad connected to the upper electrode and a connection pad connected to the lower electrode on the substrate before the step (c). Here, it is preferable that the connection pads are made of Au.

According to certain embodiments of the invention, the metal is Cu or Al.

According to an embodiment of the invention, the step (e) includes:

(i) forming a seed layer on an upper surface and exposed inner surfaces of the first photoresist layer;

(ii) forming a second photoresist layer on the seed layer, the second photoresist layer exposing a roof region which is formed above the resonance region surrounded by the sidewall region;

(iii) filling in the sidewall region and the roof region with metal to form the cap composed of the sidewall and the roof; and

(iv) removing the first and second photoresist layers.

In this embodiment, the step (a) comprises forming a trench in the substrate; and forming a sacrificial layer in the trench. In this embodiment, the method may further include selectively removing at least a part of a region extending from the passivation layer to the lower electrode to form a via connected to the sacrificial layer.

In this embodiment, the step (ii) includes forming the second photoresist layer having a via region disposed inside the roof region to cover a portion of the roof region, and the step (iii) includes forming the sidewall and the roof with a via formed in the via region.

In this embodiment, it is preferable that the via region inside the roof region is disposed outside the resonance region.

In this embodiment, the method may further include injecting an etchant through the via formed in the roof and the via extended from the passivation layer to the lower electrode to remove the sacrificial layer, thereby forming an air gap. Here, it is preferable that the metal is Cu, and the etchant is made of HF.

In this embodiment, the method may further include filling in the via formed in the roof with a predetermined material after removing the sacrificial layer. It is preferable that the material for filling in the via formed in the roof is selected from a group consisting of benzocyclobutene-based epoxy, polyamide-based epoxy, Cu, Al, an oxide and a nitride.

In this embodiment, it is preferable that the metal is filled in the sidewall region and the roof region via one selected from a group consisting of sputtering, evaporation and chemical deposition.

According to another embodiment of the invention, the step (e) includes:

(i) forming a seed layer on an upper surface and exposed inner surfaces of the first photoresist layer;

(ii) filling in the sidewall region with metal to form a sidewall and forming a metal layer made of the same metal on the seed layer;

(iii) forming a second photoresist layer on a region of the metal layer surrounded by the sidewall, the second photoresist layer exposing a portion of the metal layer through a via region;

(iv) removing the metal layer in a portion exposed by the second photoresist layer to form the roof; and

(v) removing the first and second photoresist layers.

In this embodiment, the step (a) includes forming a trench in the substrate; and forming a sacrificial layer in the trench. In this embodiment, the method may further include selectively removing at least a part of a region extending from the passivation layer to the lower electrode to form a via connected to the sacrificial layer.

In this embodiment, the step (iv) preferably includes etching the via region of the metal layer formed on a region surrounded by the sidewall to form the roof with a via formed therein. Here, it is preferable that the via formed in the roof is disposed outside the resonance region.

In this embodiment, the method may further include injecting an etchant through the via formed in the roof and the via extended from the passivation layer to the lower electrode to remove the sacrificial layer, thereby forming an air gap. Here, it is preferable that the metal is Cu, and the etchant is made of HF.

In this embodiment, it is preferable that the method may further include filling the via formed in the roof with a predetermined material after removing the sacrificial layer. It is preferable that the material for filling in the via formed in the roof is one selected from a group consisting of benzocyclobutene-based epoxy, polyamide-based epoxy, Cu, Al, an oxide and a nitride.

In this embodiment, the metal can be filled in the sidewall region and formed on the seed layer via one selected from a group consisting of sputtering, evaporation and chemical deposition.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 through 8 are sectional views and plan views illustrating a stepwise method of manufacturing an FBAR according to an embodiment of the present invention.

### DETAILED DESCRIPTION OF THE PREFERRED EMBODIMENT

Preferred embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete and will fully convey the scope of the invention to those skilled in the art. In the drawings, the shapes and dimensions may be exaggerated for clarity, and the same reference numerals are used throughout to designate the same or similar components.

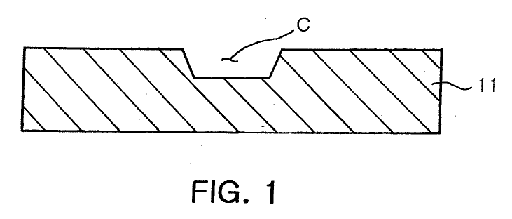

FIGS. 1 to 8 are sectional views and plan views illustrating a stepwise method of a FBAR according to an embodiment of the present invention. The method of manufacturing the FBAR is explained step by step according to an embodiment of the invention with reference to FIGS. 1 to 8.

First, as shown in FIG. 1, a cavity C is formed in an upper part of a silicon substrate 11. The cavity C is for forming an air gap which serves to separate a resonance region, formed later, from the substrate.

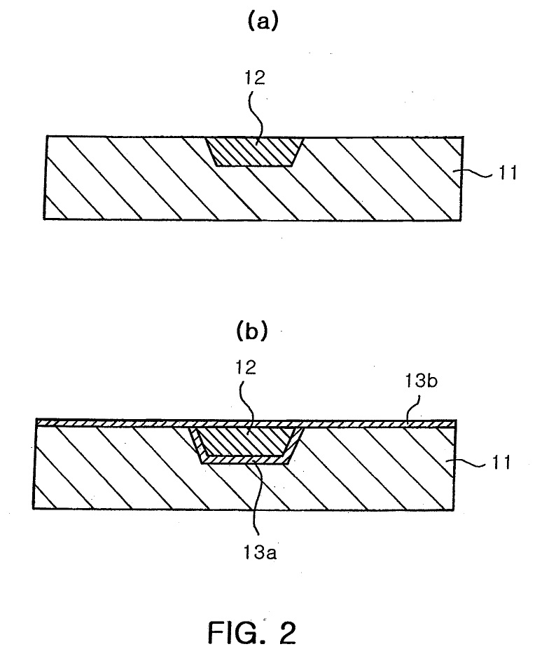

Then, as shown in FIG. 2(a), a sacrificial layer 12 is formed in the cavity of the silicon substrate 11. The sacrificial layer 12 may be made of a poly-silicon material.

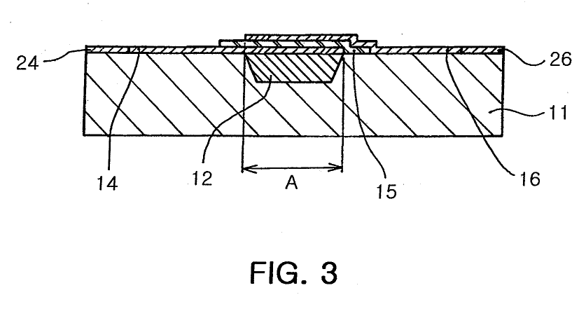

In addition, as shown in FIG. 2(b), prior to forming the sacrificial layer 12, a first insulation layer 13a may be formed to protect the silicon substrate 11 during the etching process. In a similar manner, a second insulation layer 13b can be formed after forming the sacrificial layer 12 to prevent etching of the lower electrode 14 (FIG. 3). The process of forming the first insulation layer 13a and the second insulation layer 13b is a well-known technique in the art for preventing damage to the substrate and the electrodes. In the following detailed description and drawings, the invention will be exemplified by a method which does not form the first insulation layer 13a and the second insulation layer 13b, but the method that forms the first insulation layer 13a and the second insulation layer 13b may also be included within the scope of the invention.

Next, as shown in FIG. 3, a lower electrode 14, a piezoelectric film 15 and an upper electrode 16 are sequentially stacked on the substrate 11. The lower electrode 14, the piezoelectric film 15 and the upper electrode 16 are stacked and overlapped on the sacrificial layer 12, thereby forming a resonance region A on the sacrificial layer 12. Each layer or film can be formed by repeating the steps of forming the layer or film and etching.

In addition, connection pads 24 and 26 connected respectively to the lower electrode 14 and the upper electrode 16 are formed on the silicon substrate 11. The connection pads 24 and 26 may be made of Au. The connection pads 24 and 26 serve as a connection part to be connected to an external circuit in a subsequent process.

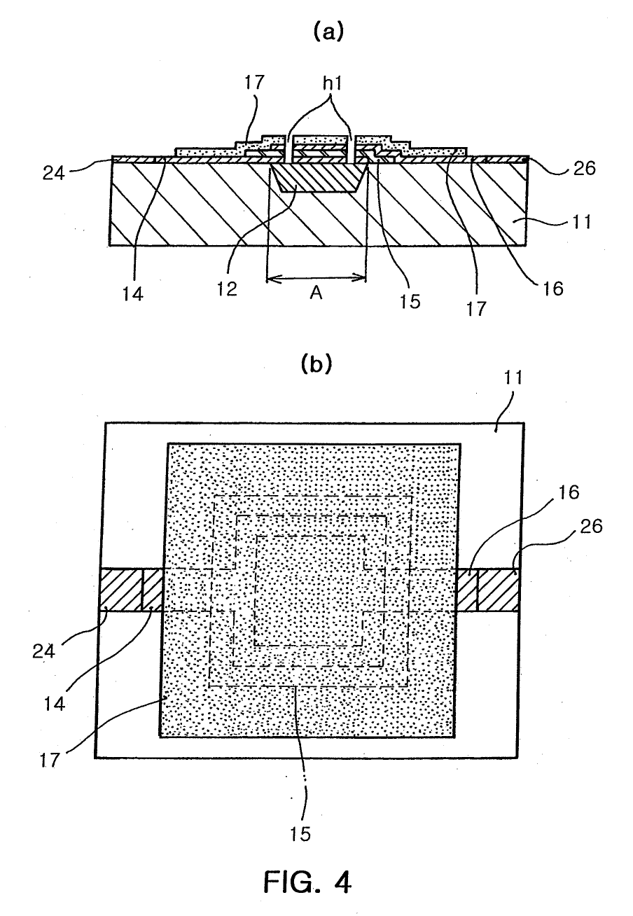

Next, as shown in FIGS. 4(a) and (b), a passivation layer 17 is formed above a substantially an entire area of the resonance region A and its adjacent region to protect the resonance region A. The passivation layer 17 may be made of an oxide or a nitride of one selected from a group consisting of Si, Zr, Ta, Ti, Hf and Al. The passivation layer 17 can be formed by a typical method such as one selected from a group consisting of sputtering, evaporation and chemical deposition. The passivation layer 17 not only serves to protect the resonance region A composed of the lower electrode 14, the piezoelectric film 15 and the upper electrode 16, but also electrically isolate a cap made of metal formed later, the resonance region A and upper and lower electrodes 16 and 14.

In the meantime, vias h1 can be formed in advance through a suitable etching process, which will be used for removing the sacrificial layer 12 to form an air gap during an etching process later. The vias h1 are formed by selectively removing at least a part of a region extending from the stacked passivation layer 17 to the lower electrode 14 to be connected to the sacrificial layer 12.

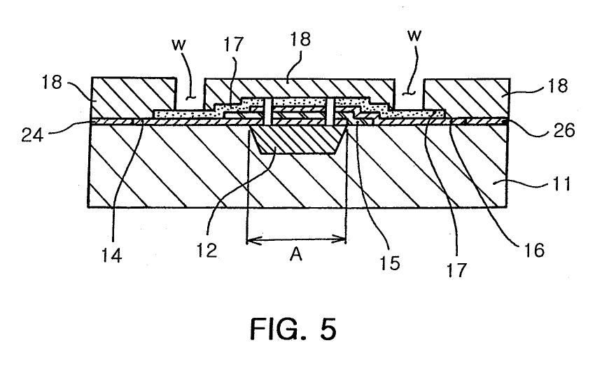

Next, as shown in FIG. 5, a first photoresist layer 18 is formed on the passivation layer 17, exposing a sidewall region w surrounding the resonance region A. The sidewall region w, which is a region to be filled with metal to form a sidewall of a cap, is formed on the passivation layer 17.

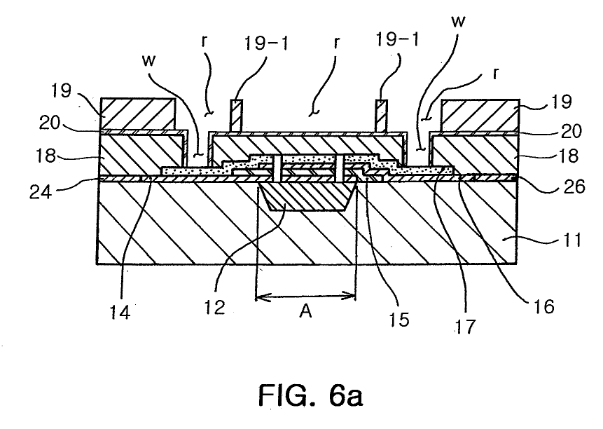

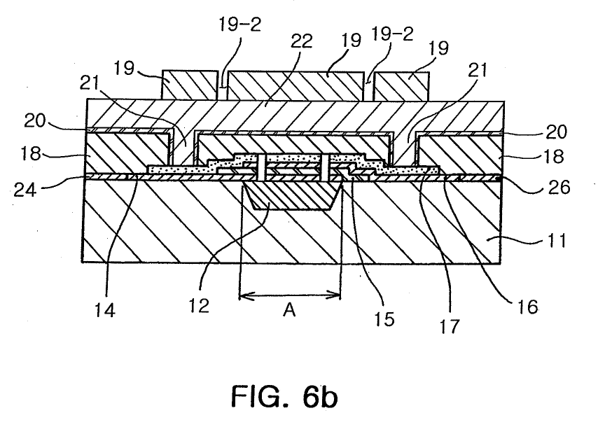

After the first photoresist layer 18 is formed through the above described steps with reference to FIGS. 1 to 5, the cap can be formed by either of the following two methods, which are illustrated in FIGS. 6a and 6b, respectively.

First, with reference to FIG. 6a, a seed layer 20 is formed on an upper surface and exposed inner surfaces of the first photoresist layer 18, and then a second photoresist layer 19 having a roof region r exposed above the resonance region surrounded by the sidewall region w is formed.

The seed layer 20 provides a base which facilitates forming the sidewall and the roof, which will be formed with metal later, while preventing any effects to the first photoresist layer 18 during the exposure to light when the second photoresist layer 19 is patterned.

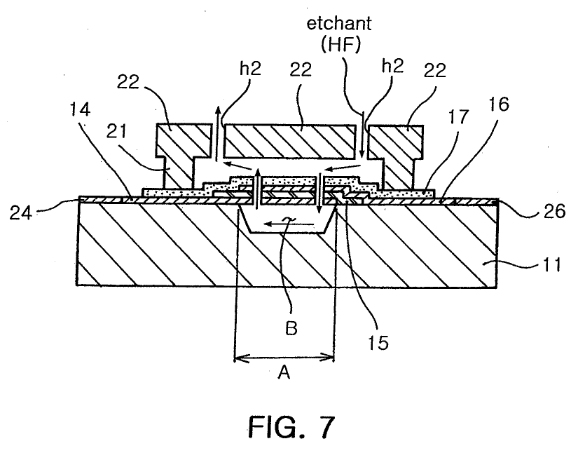

In this embodiment, in order to form vias in the roof of the cap formed later, the second photoresist layer 19 may expose the roof region r formed above the resonance region surrounded by the sidewall region w, and may have via regions 19-1 inside the roof region r to cover portions of the roof region r. These via regions 19-1 enable the formation of vias h2 (FIG. 7) penetrating through the roof of the cap later.

It is preferable that the via regions 19-1 in the roof region w are disposed outside the resonance region A. This is because, during a later process of filling in the vias h2 (FIG. 7) formed in the roof of the cap by the via regions 19-1, material for filling up the vias h2 may be deposited on the resonance region A, disadvantageously changing or degrading the resonance characteristics of the device.

As described above, after completing the first and second photoresist layers 18 and 19 for forming the sidewall and the roof of the cap, the sidewall region w and the roof region r formed by the first and second photoresist layers 18 and 19 are filled with metal. Thereby, as shown in FIG. 7, the cap composed of the sidewall 21 and the roof 22 is formed, and the first and second photoresist layers are removed. It is preferable that the metal is filled in the sidewall region w and the roof region r via one selected from a group consisting of sputtering, evaporation and chemical deposition.

As an alternative to form the cap, with reference to FIG. 6b, after the seed layer 20 is formed on an upper surface and exposed inner surfaces of the first photoresist layer 18, the sidewall region w (FIG. 5) is filled with metal, and a metal layer is formed on the upper surface of the seed layer 20 in a predetermined thickness with the same metal. A part of the metal filled in the sidewall region w (FIG. 5) forms the sidewall 21 and another part of the metal layer forms the roof 22. It is preferable that the metal is filled in the sidewall region w (FIG. 5) and formed on the seed layer 20 via one selected from a group consisting of sputtering, evaporation and chemical deposition.

Next, a second photoresist layer 29 is formed on the metal layer. The second photoresist layer 19 is patterned so as to expose portions of the metal layer to be removed later such as by etching. That is, via regions 19-2 for forming vias as well as useless peripheral regions can be exposed. Parts of the metal layer are etched using the second photoresist layer 19 as an etching mask, thereby completing the roof 22 of the cap with the vias h2 formed therein as shown in FIG. 7.

As explained hereinabove with reference to FIG. 6a, it is preferable that the via regions h2 formed in the roof 22 are disposed outside the resonance region A. This is because during a later process of filling in the vias h2, the material for filling up the vias may be deposited on the resonance region A, disadvantageously changing or degrading the resonance characteristics of the device.

Then, the first and second photoresist layers are removed to complete the cap.

Next, as shown in FIG. 7, an air gap B is formed using the vias h2 formed in the roof 22 of the cap. According to this embodiment of the invention, the vias h2 are formed in the roof 22 of the cap. The vias h2 serve as paths for supplying and retrieving a developing solution for removing the first photoresist layer 18 (FIG. 6) formed inside the sidewall 21. At the same time, the vias h2 together with the vias h1 serve as paths for supplying and retrieving an etchant for removing the sacrificial layer 12 (FIG. 6) to form the air gap B (refer to the arrows in FIG. 7).

For the etchant, an ingredient that does not affect the metal constituting the cap should be selected. For example, if the metal is Cu, the etchant may adopt HF which cannot etch Cu. Conversely, if the etchant is determined first, the type of the metal can be selected accordingly.

The process of removing the sacrificial layer 12 (FIG. 6) to form the air gap B can be conducted before the process of forming the photoresist layers and forming the cap. However, the material constituting the photoresist layers or the cap may infiltrate the air gap B to degrade the characteristics of the FBAR. Thus, it is preferable that the air gap B is formed after the cap is formed, through the vias.

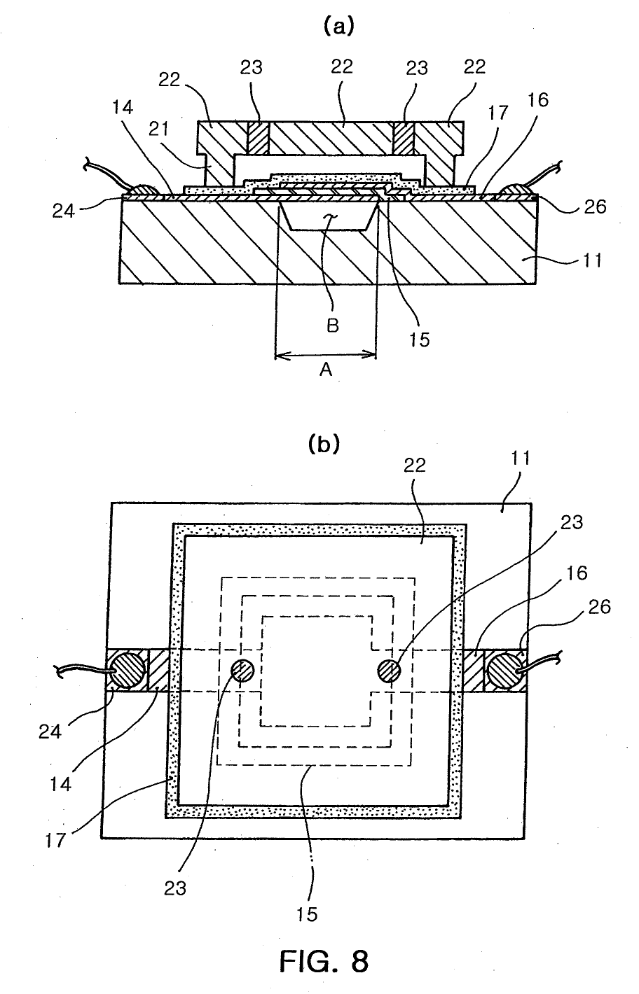

Lastly, as shown in FIGS. 8(a) and (b), the vias h2 (FIG. 7) formed in the roof 22 of the cap are filled with a predetermined material to complete the FBAR. The material for filling the vias h2 (FIG. 7) may be various materials, and preferably, one selected from a group consisting of benzocyclobutene-based epoxy, polyamide-based epoxy, Cu, Al, an oxide and a nitride.

If the vias h2 (FIG. 7) formed in the roof of the cap are too large, the material may not fill up the vias and drip downward. In this case, it is preferable that the vias are made to have a smaller diameter by electroless/electro-plating and then is filled with one of the above materials.

The FBAR completed through the above-described process can be wire-bonded to an external circuit by the connection pads 24 and 26 exposed outside the cap as shown in FIG. 8. This embodiment is exemplified by a wire-bonding structure but the invention is not limited thereto and may adopt a flip-chip bonding structure.

In the manufacturing method of the FBAR according to the present invention, the cap is formed through relatively simple processes such as the well-known photoresist method with solid metal, and thereby prevented from being damaged during a molding process later. In particular, the cap can be formed with conductive metal, thereby protecting the resonance region of the FBAR from external electromagnetic waves.

According to the present invention set forth above, a cap is made of solid metal, thus prevented from being damaged by external force. Further, the cap can be formed with conductive metal to protect a resonance region of an FBAR from external electromagnetic waves. In particular, a relatively simple semiconductor process such as the well-known photoresist process is used to form the cap, thereby simplifying the manufacturing process while reducing the manufacturing costs of the FBAR.

While the present invention has been shown and described in connection with the preferred embodiments, it will be apparent to those skilled in the art that modifications and variations can be made without departing from the spirit and scope of the invention as defined by the appended claims.

What is claimed is:

1. A method of manufacturing a Film Bulk Acoustic Resonator (FBAR) comprising steps of:
(a) preparing a substrate;
(b) stacking a lower electrode, a piezoelectric film and an upper electrode on the substrate to form a resonance region in which the lower electrode, the piezoelectric film and the upper electrode are overlapped on one another;
(c) forming a passivation layer above substantially an entire area of the resonance region and its adjacent region to protect the resonance region;
(d) forming a first photoresist layer on the passivation layer, the first photoresist layer exposing a sidewall region which surrounds the resonance region; and
(e) filling in the sidewall region with metal and forming a roof with the same metal on the resonance region surrounded by the sidewall region, thereby forming a cap composed of the sidewall and the roof.

2. The method according to claim 1, wherein the passivation layer is made of an oxide or a nitride of one selected from a group consisting of Si, Zr, Ta, Ti, Hf and Al.

3. The method according to claim 1, wherein the step (c) comprises one selected from a group consisting of sputtering, evaporation and chemical deposition.

4. The method according to claim 1, further comprising forming a connection pad connected to the upper electrode and a connection pad connected to the lower electrode on the substrate before the step (c).

5. The method according to claim 4, wherein the connection pads are made of Au.

6. The method according to claim 1, wherein the metal is Cu or Al.

7. The method according to claim 1, wherein the step (e) comprises:
(i) forming a seed layer on an upper surface and exposed inner surfaces of the first photoresist layer;
(ii) forming a second photoresist layer on the seed layer, the second photoresist layer exposing a roof region which is formed above the resonance region surrounded by the sidewall region;
(iii) filling in the sidewall region and the roof region with metal to form the cap composed of the sidewall and the roof; and
(iv) removing the first and second photoresist layers.

8. The method according to claim 7, wherein the step (a) comprises forming a trench in the substrate; and forming a sacrificial layer in the trench,
the method further comprising selectively removing at least a part of a region extending from the passivation layer to the lower electrode to form a via connected to the sacrificial layer.

9. The method according to claim 8, wherein the step (ii) comprises forming the second photoresist layer having a via region disposed inside the roof region to cover a portion of the roof region, and
the step (iii) comprises forming the sidewall and the roof with a via formed in the via region.

10. The method according to claim 9, wherein the via region inside the roof region is disposed outside the resonance region.

11. The method according to claim 9, further comprising injecting an etchant through the via formed in the roof and the via extended from the passivation layer to the lower electrode to remove the sacrificial layer, thereby forming an air gap.

12. The method according to claim 11, wherein the metal is Cu, and the etchant is made of HF.

13. The method according to claim 11, further comprising filling in the via formed in the roof with a predetermined material after removing the sacrificial layer.

14. The method according to claim 13, wherein the material for filling in the via formed in the roof is selected from a group consisting of benzocyclobutene-based epoxy, polyamide-based epoxy, Cu, Al, an oxide and a nitride.

15. The method according to claim 7, wherein the metal is filled in the sidewall region and the roof region via one selected from a group consisting of sputtering, evaporation and chemical deposition.

16. The method according to claim 1, wherein the step (e) includes:
(i) forming a seed layer on an upper surface and exposed inner surfaces of the first photoresist layer;
(ii) filling in the sidewall region with metal to form a sidewall and forming a metal layer made of the same metal on the seed layer;
(iii) forming a second photoresist layer on a region of the metal layer surrounded by the sidewall, the second photoresist layer exposing a portion of the metal layer through a via region;
(iv) removing the metal layer in a portion exposed by the second photoresist layer to form the roof; and
(v) removing the first and second photoresist layers.

17. The method according to claim 16, wherein the step (a) comprises forming a trench in the substrate; and forming a sacrificial layer in the trench,
the method further comprising selectively removing at least a part of a region extending from the passivation layer to the lower electrode to form a via connected to the sacrificial layer.

18. The method according to claim 17, wherein the step (iv) comprises etching the via region of the metal layer formed on a region surrounded by the sidewall to form the roof with a via formed therein.

19. The method according to claim 18, wherein the via formed in the roof is disposed outside the resonance region.

20. The method according to claim 18, further comprising injecting an etchant through the via formed in the roof and the via extended from the passivation layer to the lower electrode to remove the sacrificial layer, thereby forming an air gap.

21. The method according to claim 20, wherein the metal is Cu, and the etchant is made of HF.

22. The method according to claim 20, further comprising filling the via formed in the roof with a predetermined material after removing the sacrificial layer.

23. The method according to claim 21, wherein the material for filling in the via formed in the roof is one selected from a group consisting of benzocyclobutene-based epoxy, polyamide-based epoxy, Cu, Al, an oxide and a nitride.

24. The method according to claim 16, wherein the metal is filled in the sidewall region and formed on the seed layer via one selected from a group consisting of sputtering, evaporation and chemical deposition.

25. A method of manufacturing a Film Bulk Acoustic Resonator (FBAR) comprising steps of:
(a) preparing a substrate with a trench formed therein and a sacrificial layer formed in the trench;
(b) stacking a lower electrode, a piezoelectric film and an upper electrode in their order on the substrate to form a resonance region in which the lower electrode, the piezoelectric film and the upper electrode are overlapped on one another;
(c) forming a passivation layer above substantially en entire area of the resonance region and its adjacent region to protect the resonance region;
(d) selectively removing at least a part of a region extending from the passivation layer to the lower electrode to form a via connected to the sacrificial layer;
(e) forming a first photoresist layer on the passivation layer, the first photoresist layer exposing a sidewall region surrounding the resonance region;
(f) forming a seed layer on an upper surface and exposed inner surfaces of the first photoresist layer;
(g) forming a second photoresist layer on the seed layer, the second photoresist layer exposing a roof region above the resonance region surrounded by the sidewall region and having a via region disposed inside the roof region to cover a portion of the roof region;
(h) filling in the sidewall region and the roof region with metal to form a sidewall and a roof having a via formed in the via region and removing the first and second photoresist layers;
(i) injecting an etchant through the via formed in the roof and the via extended from the passivation layer to the lower electrode to remove the sacrificial layer, thereby forming an air gap; and
(j) filling in the via formed in the roof with a predetermined material.

26. The method according to claim 25, wherein the passivation layer is made of an oxide or a nitride of one selected from a group consisting of Si, Zr, Ta, Ti, Hf and Al.

27. The method according to claim 25, wherein the step (c) comprises forming a passivation layer via one selected from a group consisting of sputtering, evaporation and chemical deposition.

28. The method according to claim 25, further comprising forming a connection pad connected to the upper electrode and a connection pad connected to the lower electrode on the substrate before the step (c).

29. The method according to claim 28, wherein the connection pads are made of Au.

30. The method according to claim 25, wherein the metal is Cu or Al.

31. The method according to claim 25, wherein the metal is filled in the sidewall region and the roof region via one selected from a group consisting of sputtering, evaporation and chemical deposition.

32. The method according to claim 25, wherein the via region in the roof region is disposed outside the resonance region.

33. The method according to claim 25, wherein the metal is Cu, and the etchant is made of HF.

34. The method according to claim 25, wherein the material for filling in the via formed in the roof is one selected from a group consisting of benzocyclobutene-based epoxy, polyamide-based epoxy, Cu, Al, an oxide and a nitride.

35. A method of manufacturing a FBAR comprising steps of:
(a) preparing a substrate with a trench formed therein and a sacrificial layer formed in the trench;
(b) stacking a lower electrode, a piezoelectric film and an upper electrode in their order on the substrate to form a resonance region with the lower electrode, the piezoelectric film and the upper electrode overlapped on one another;
(c) forming a passivation layer above substantially an entire area of the resonance region and its adjacent region to protect the resonance region;
(d) selectively removing at least a part of a region extending from the passivation layer to the lower electrode to form a via connected to the sacrificial layer;
(e) forming a first photoresist layer on the passivation layer, the first photoresist layer exposing a sidewall region surrounding the resonance region;
(f) forming a seed layer on an upper surface and exposed inner surfaces of the first photoresist layer;
(g) filling in the sidewall region with metal to form a sidewall and forming a metal layer with the same metal on the seed layer;
(h) forming a second photoresist layer on a region of the metal layer surrounded by the sidewall, the second photoresist layer exposing a portion of the metal layer through a via region;
(i) removing the metal layer in the portion exposed by the second photoresist layer to form a roof with a via formed in the via region and removing the first and second photoresist layers;
(j) injecting an etchant through the via formed in the roof and the via extended from the passivation layer to the lower electrode to remove the sacrificial layer, thereby forming an air gap; and
(k) filling in the via formed in the roof with a predetermined material.

36. The method according to claim 35, wherein the passivation layer is made of an oxide or nitride of one selected from a group consisting of Si, Zr, Ta, Ti, Hf and Al.

37. The method according to claim 35, wherein the step (c) comprises forming a passivation layer via one selected from a group consisting of sputtering, evaporation and chemical deposition.

38. The method according to claim 35, further comprising forming a connection pad connected to the upper electrode and a connection pad connected to the lower electrode on the substrate before the step (c).

39. The method according to claim 38, wherein the connection pads are made of Au.

40. The method according to claim 35, wherein the metal is Cu or Al.

41. The method according to claim 35, wherein the metal is filled in the sidewall region and the metal layer is formed on the seed layer via one selected from a group consisting of sputtering, evaporation and chemical deposition.

42. The method according to claim 35, wherein the via formed in the roof is disposed outside the resonance region.

43. The method according to claim 35, wherein the metal is Cu, and the etchant is made of HF.

44. The method according to claim 35, wherein the metal for filling in the via formed in the roof is one selected from a group consisting of benzocyclobutene-based epoxy, polyamide-based epoxy, Cu, Al, an oxide and a nitride.
